(19) United States
(12) Patent Application Publication
(10) Pub. No.: US 2013/0219038 A1
(43) Pub. Date: Aug. 22, 2013

(54) ROUTER BASED ON CORE SCORE AND METHOD FOR SETTING CORE SCORE AND PROVIDING AND SEARCHING CONTENT INFORMATION THEREIN

(71) Applicant: Electronics and Telecommunications Research Institute, (US)

(72) Inventor: Byung-Joon LEE, Daejeon-si (KR)

(73) Assignee: Electronics and Telecommunications Research Institute, Daejeon-si (KR)

(21) Appl. No.: 13/768,749

(22) Filed: Feb. 15, 2013

(30) Foreign Application Priority Data
Feb. 17, 2012 (KR) 10-2012-0016123
Sep. 28, 2012 (KR) 10-2012-0109409

(51) Int. Cl. H04L 12/56

(52) U.S. Cl. CPC H04L 45/02
USPC 709/223

(57) ABSTRACT

The method for setting a core score in a router on a Content-Centric Network (CCN) includes setting a core score according to closeness to a core of a CCN; and transmitting the core score to one or more adjacent routers.

### CROSS-REFERENCE TO RELATED APPLICATION

This application claims the benefit under 35 U.S.C. §119(a) of Korean Patent Applications Nos. 10-2012-0016123, filed on Feb. 17, 2012, and 10-2012-0109409, filed on Sep. 28, 2012, the entire disclosure of which is incorporated herein by reference for all purposes.

### BACKGROUND

1. Field

The following description relates to an apparatus based on a core score, which realizes a control plane on a Content-Centric Network (CCN) to request and transmit a piece of content, and a method thereof.

2. Description of the Related Art

A lot of researches have been conducted to seek a new architecture of computer networks, and, so far, a Content-Centric Network (CCN) is considered as a typical architecture of computer networks.

The CCN is an alternative approach to the architecture of computer networks. Its founding principle is that a communication network should allow a user to focus on the data he or she needs, rather than having to reference to a specific, physical location where that data is to be retrieved from. The CCN was first proposed by Van Jacobson, a renowned computer scientist at PARC.

A piece of content is transmitted on a CCN using an interest packet and a data packet. At this time, the interest packet is named pieces of content requested by a user, and the data packet which is transmitted from a node storing the pieces of content. At this time, a course of determining nodes to transmit the interest packet is called routing. If receiving the interest packet in this manner, the router transmits the received interest packet using a Forward Information Base (FIB) to another router. That is, if a name of the interest packet may be found in categories of the FIB, the interest packet is transmitted to a different node. Meanwhile, the data packet is transmitted on a reverse path of the interest packet.

However, a conventional CCN router extends a routing protocol, such as an Open Shortest Path First (OSPF). Specifically, a role of a control plane in the conventional CCN router is to install meta-information in every router belonging to the CCN. However, it takes some time to spread content location information throughout the CCN using such a distributed routing protocol, such as an OSPF protocol, so that stable mobility of content cannot be guaranteed.

### SUMMARY

The following description relates to an apparatus and a method for quickly spreading content location information throughout a network without a distributed routing protocol, such as an Open Shortest Path First (OSPF) protocol.

In one general aspect of the present invention, a method for setting a core score in a router on a Content-Centric Network (CCN) is provided, and the method includes setting a core score according to closeness to a core of a CCN; and transmitting the core score to one or more adjacent routers.

In another general aspect of the present invention, a method for providing content information based on a core score in a router on a CCN is provided, and the method includes generating a register message comprising information about a piece of content stored in a router; and transmitting the generated register message to one or more adjacent routers which have core scores equal to or greater than that of the router.

In another general aspect of the present invention, a method for providing content information based on a core score in a router on a CCN is provided, and the method includes receiving a register message from one or more adjacent routers; storing the received message; modifying content distance information included in the received register message; and transmitting the modified content distance information to adjacent routers which have core scores equal to or greater than that of a corresponding router.

In another general aspect of the present invention, a router based on a core score is provided, and the router includes a core score setting unit configured to set a core score according to closeness to a core of a CCN; and a core score transmitting/receiving unit configured to transmit the core score to one or more routers.

Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating configurations of two packets used on a Content-Centric Network (CCN);

FIG. 2 is a diagram illustrating a CCN router which uses a core score according to an exemplary embodiment of the present invention;

FIG. 3 is a diagram illustrating a configuration of a CCN in which core scores are set to every CCN routers according to an exemplary embodiment of the present invention;

FIG. 4 is a flow chart illustrating a method for setting a core score according to an exemplary embodiment of the present invention;

FIG. 5 is a flow chart illustrating a method for providing content information based on a core score according to an exemplary embodiment of the present invention; and

FIG. 6 is a flow chart illustrating a method for searching for a piece of content based on a core score according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

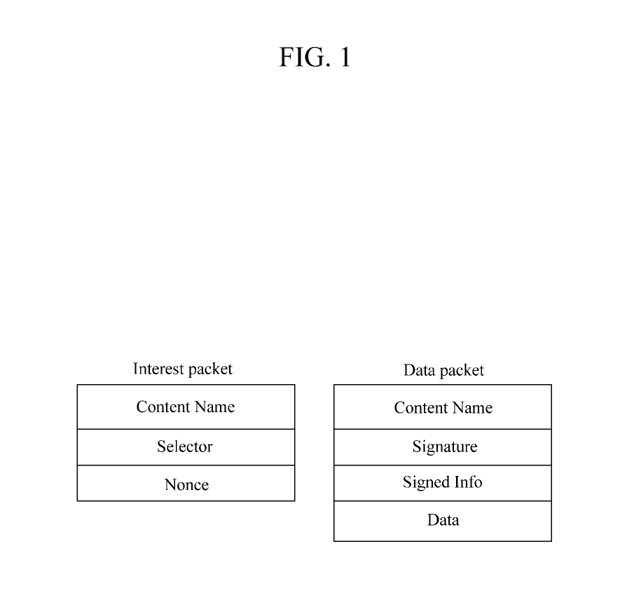

FIG. 1 is a diagram illustrating configurations of two packets on a Content Centric Network (CCN).

As illustrated in FIG. 1, two terminals are able to communicate with each other using an interest packet and a data packet on a CCN. If a user wishes to receive a specific piece of content, an interest packet including a content name of the specific piece of content is relayed to the CNN, as illustrated in FIG. 1. If receiving the interest packet, a CCN router transmits the received interest packet using a Forward Information Base (FIB). That is, a name of the interest packet is found in categories of the FIB, the CCN router transmits the interest packet to a next CCN router specified in the FIB. If the piece of content indicated by the interest packet is stored in the CCN router, the CCN router transmits a data packet, as shown in FIG. 1, on a reverse path of the interest packet.

A commonly-used CCN router extends a conventional routing protocol, such as an Open Shortest Path First (OSPF) protocol to configure the above-described FIB. In addition, a primary role of a control plane in a commonly-used network router is an installation of meta-information which is required to transmit a packet to all routers belonging to the same network. Thus, it is concluded that a commonly-used CCN router uses a control plane which is based on a routing protocol, such as an OSPF protocol. However, if a distributed routing protocol like OSPF protocol is used, it takes a long time to spread a content location information throughout a CCN, and thus, stable mobility of content may not be guaranteed.

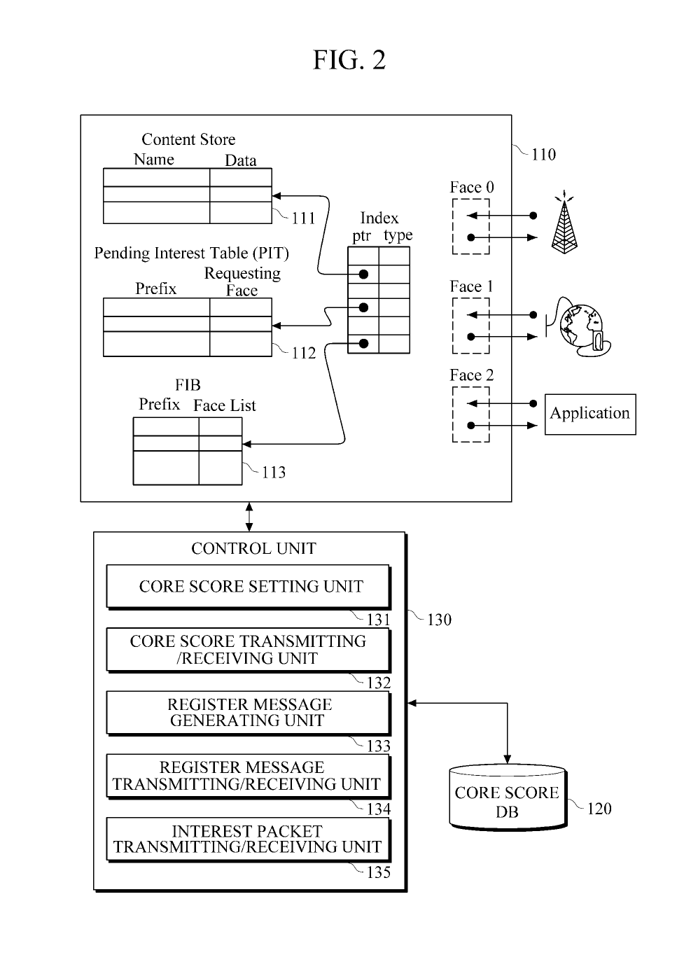

For this reason, the present invention discloses a technical feature that every router belonging to the same CCN has a core score. A core score is a value representing closeness of a corresponding CCN router to a core of a CCN. An apparatus and a method for providing content information using a core score will be provided with reference to FIGS. 2 through 6.

FIG. 2 is a diagram illustrating a configuration of a CCN router which uses a core score according to an exemplary embodiment of the present invention.

Referring to FIG. 2, the CCN router includes a storage unit 110, a core score Database (DB) 120 and a control unit 130.

Specifically, the storage unit 110 includes a content store 111, a Pending Interest Table (PIB) 112 and a Forwarding Information Base (FIB) 113.

The content store 111 may be configured in a form of a table which includes a content name and content data to inform what kinds of pieces of content are stored in the content store 111. The control unit 130 looks up the content store 111 to see if a piece of content indicated by an interest packet is stored therein.

For the purpose of transmitting a data packet, the PIB 112 stores information about an interface which has received an interest packet, and information that the interest packet is transmitted.

If the corresponding piece of content is not found in the content store 111, the FIB 113 stores location information about an adjacent CCN router to which the interest packet is to be forwarded. Accordingly, if the corresponding piece of content is not found, the control unit 130 searches for the FIB 113 to decide the adjacent CCN router to which the interest packet is to be forwarded.

The core score DB 120 stores core scores of the corresponding CCN router and other adjacent CCN routers. As described above, a core score is a value representing closeness of a corresponding CCN router to a core of a CCN.

Specifically, the control unit 130 includes a core score setting unit 131, a core score transmitting/receiving unit 132, a register message generating unit 133, a register message transmitting/receiving unit 134 and an interest packet transmitting/receiving unit 135.

The core score setting unit 131 sets a core score indicating how close a corresponding CCN router is placed to a center of a CCN. According to an exemplary embodiment of the present invention, every router installed in the same CCN has a core score. According to an exemplary embodiment of the present invention, it is possible to set such that the greater a core score, the more adjacent a corresponding CCN router is to a core of a CCN. However, it is merely exemplary, and it is also possible that the lower a core score, the more adjacent a corresponding CCN router is to a core of a CCN.

In the case of an automatically setting of a core score, a core score may be calculated using a link bandwidth of a CCN router. For example, in the case where a CCN router has two links of 100Mbps and two links of 10Mbps, a core score is able to be calculated by multiplying the number of links with the greatest bandwidth, that is, 2, to a value of the greatest bandwidth and then adding the multiplied value, that is, 200, to a value of other bandwidth, that is 100. According to the above calculation, the CCN router has a core score of 300.

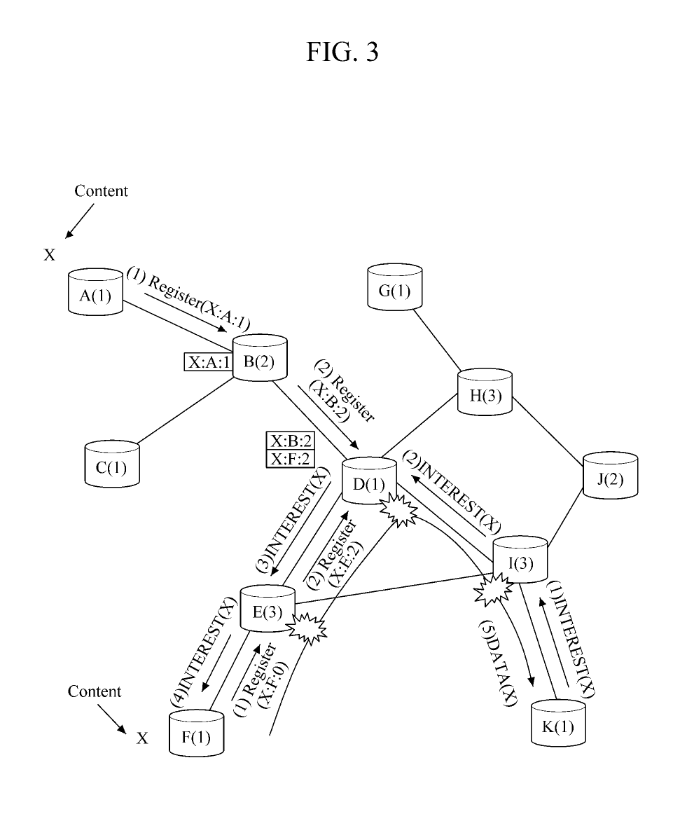

FIG. 3 is a diagram illustrating a configuration of a CCN where a core score is given to every CCN router according to an exemplary embodiment of the present invention.

Referring to FIG. 3, every CCN router is indicated by an arbitrary alphabet letter for the sake of explanation, but the present invention is not limited thereto. Each value in every bracket is a core score of a corresponding CCN router.

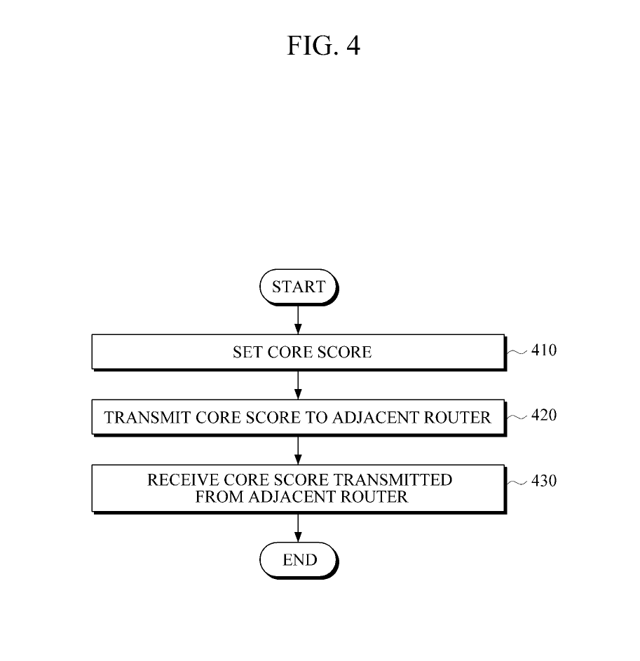

Again, referring to FIG. 2, the core score transmitting/receiving unit 132 transmits a core score of a corresponding CCN router to an adjacent CCN router, and stores a core score received from the adjacent CCN router in the core score DB 120. A more detailed description about the above will be provided with reference to FIG. 4.

The register message generating unit 133 generates a register message necessary to transmit content location information. A register message includes a content name, a location of a piece of content, and a value indicating a distance to the piece of content. In addition, the distance to a piece of content means the number of CCN routers which need to be gone through to reach the corresponding piece of content. For example, if a piece of content is located in an adjacent CCN router, a value of a distance is “1.” On the other hand, if a piece of content is located in another CCN router next to the adjacent CCN router, a value of a distance is “2.”

A register message generated by the register message generator 113 indicates information about a piece of content stored in the content store 111 belonging to the same CCN router. In this case, the content location means the CCN router, and a value of a distance is “1.” With regard to another CCN router which is to receive the register message, content location is the specific CCN router and a value of a distance is “1.”

The register message transmitting/receiving unit 134 transmits the generated register message to every adjacent CCN router whose a core score is equal to or greater than that of a corresponding CCN router.

In addition, if receiving a register message from an adjacent CCN router, the register is message transmitting/receiving unit 134 converts location information about a CCN router which has stored a piece of content indicated by the received register message into an FIB. At this time, if two or more register messages indicating a specific piece of content are received, location information included in all of the register messages may be converted into an FIB and then stored. On the other hand, if a received register message is able to replace an existing FIB, that is, if a register message is not a new message, the register message is dropped.

In addition, if a register message is converted into an FIB, the register message transmitting/receiving unit 134 generates a new register message and transmits the new register message to a CCN router whose a core score is equal to or greater than that of a corresponding CCN router to which the register message transmitting/receiving unit 134 belongs. At this time, the new register message should not be transmitted to the CCN router which transmitted the register message, even if a core score of the CCN router is equal to that of the corresponding CCN router to which the register message transmitting/receiving unit 134 belongs.

For example, referring to FIG. 3, a CCN router B generates a register message by recording information that a piece of content X is located in a CCN router A and that the distance to the corresponding piece of content X is “1.” The CCN router B generates a register message indicating that a piece of content X is able to be found via the CCN router B and that a value of a distance is “2”, and then transmits the register message to a CCN router D. The above-described process is performed repeatedly until no CCN router is with a core score equal to or greater than that of a corresponding CCN router.

Meanwhile, a CCN router which wishes to use a piece of content registered in a CCN is able to find the corresponding piece of content using an interest packet, as is a conventional method.

Referring to FIG. 2, the interest packet transmitting/receiving unit 135 searches for a CCN router which has stored a piece of content indicated by a received interest packet. Specifically, first of all, the interest packet transmitting/receiving unit 135 looks up the content store 111 to see if the piece of content is stored therein. At this time, the interest packet may be transmitted to various kinds of network devices (for example, terminals, access points and routers) connected to a corresponding network.

According to an exemplary embodiment of the present invention, when an interest packet is transmitted to a next CCN router, a core score as well as an FIB is used.

That is, a CCN router which wishes to use a piece of content needs to generate and transmit an interest packet. In this case, if there is no FIB corresponding to the piece of content, the CCN router has to transmit the interest packet to every CCN router whose a core score is equal to or greater than that of the corresponding CCN router.

Referring to FIG. 3, a CCN router K generates an interest packet and transmits the interest packet to a CCN router which has the greatest core score among all adjacent CCN routers, because an FIB corresponding to a piece of content X is not stored in the CCN router K. For the CCN router K, the CCN router which has the greatest core score is a CCN router I. If no CCN router is found with a core score greater than that of the CCN router K, transmitting the interest packet is abandoned and instead it is determined that the piece of content X is unable to be found.

When receiving an interest packet, a CCN router looks up elements of its own to see if a requested piece of content is stored therein. If the piece of content is found, the corresponding

CCN router generates a data packet, as a conventional CCN networking method does, and transmits the requested piece of content using the data packet. For example, such a CCN router is a CCN router K in FIG. 3. If a piece of content indicated by an interest packet is not stored in a corresponding CCN router which has received the interest packet, following operations are performed sequentially.

That is, if there is no FIB corresponding to a received interest packet, a corresponding CCN router transmits the interest packet to every CCN router which has a core score equal to or greater than that of the corresponding CCN router. For example, if a CCN router I receives an interest packet indicating a piece of content X, the CCN router I transmits the interest packet to a CCN router D with a core score equal to or greater than that of the CCN router I, because there is no FIB corresponding to the piece of content X. Meanwhile, if there is an FIB corresponding to a piece of content, an interest packet is transmitted in a direction specified in the FIB. If the CCN router D receives an interest packet requesting the piece of content X, the CCN router D transmits the interest packet in a direction specified in the FIB. That is, the CCN router D transmits the interest packet to the CCN router B or the CCN router E. If the interest packet is transmitted either to the CCN router B or to the CCN router E, the interest packet is transmitted to a CCN router which has a small value of a distance or the first or the last CCN router which has been registered.

It is assumed in the present invention that a router to which an interest packet may be forwarded may be set according to how a CCN router is set. For example, an interest packet is transmitted according to the latest-registered FIB in the above exemplary embodiment of the present invention, for the sake of explanation. However, it is desirable that an interest packet needs to be transmitted to every router belonging to the same network for the purpose of supporting data mobility, and the present invention is able to operate properly even in such a case. However, if there is no FIB corresponding to a piece of content and no adjacent CCN router is found with a core score equal to or greater than that of a corresponding CCN router, the interest packet is dropped, rather than being transmitted.

According to an exemplary embodiment of the present invention, FIBs are installed along a path from a CCN router which has stored a piece of content to other CCN routers adjacent to a core of a CCN, unlike the case where a routing protocol is used. Thus, fewer FIBs are installed on a network, compared to when a routing protocol is used.

In addition, according to an exemplary embodiment of the present invention, it is not necessary to install a routing protocol, such as an OSPF protocol, so that a router with a simpler configuration may be achieved. However, without a routing protocol like an OSPF protocol, it is hard to monitor information about an entire network to see which CCN router each piece of content is located in.

To solve the above drawback, a server is placed next to a CCN router with the greatest core score among all CCN routers, and a core score of the server is greater than that of the corresponding CCN router. In addition, a CCN router is set to receive a register message, but not to transmit an interest packet. Under the above condition, it is easy for a monitoring server to be informed which CCN router a piece of content is located in.

FIG. 4 is a flow chart illustrating a method for setting a core score according to an exemplary embodiment of the present invention.

Referring to FIG. 4, a CCN router sets a core score of its own in 410. As described above, a core score indicates a value representing closeness of a corresponding CCN router to a core of a CCN. According to an exemplary embodiment of the present invention, every router belonging to the same CCN has a core score, and it is possible to set such that the greater core score, the more adjacent the corresponding CCN router is to a core of the CCN. However, the above is merely exemplary, and the present invention is not limited thereto. That is, it is also possible to set such that the smaller the core score, the more adjacent the corresponding CCN router is to a core of a network. In addition, a core score may be set automatically or manually. In the case of an automatic setting, a core score may be calculated using a link bandwidth of a corresponding CCN router.

Next, the CCN router transmits the core score to an adjacent CCN router in 420. The adjacent CCN router stores the received core score in a core score DB 120 in 430.

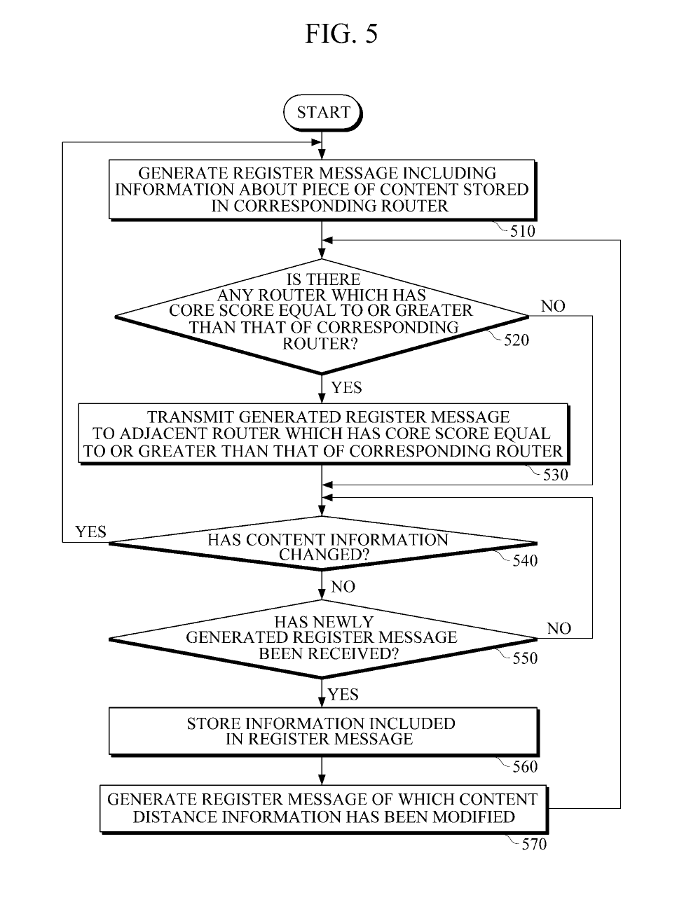

FIG. 5 is a flow chart illustrating a method for providing content information based on a core score according to an exemplary embodiment of the present invention.

Referring to FIG. 5, a CCN router generates a register message including information about a piece of content stored in the CCN router in operation 510. A register message includes a content name, content location, and a value representing a distance to a corresponding piece of content. The distance to the corresponding piece of content means the number of CCN routers that need to be gone through to reach to the piece of content. For example, if a piece of content is able to be found in an adjacent CCN router, a value of a distance is “1.” If a piece of content able to be found in another CCN router next to the adjacent CCN router, a value of a distance is “2.” In addition, the CCN router transmits the generated register message to adjacent CCN routers which have core scores equal to or greater than that of the corresponding CCN router.

Accordingly, the CCN router determines whether any adjacent CCN router has a core score equal to or greater than that of the corresponding CCN router in operation 520.

If it is determined that there is an adjacent CCN router with a core score equal to or greater than that of the corresponding CCN router in operation 520, the CCN router transmits the generated register message to the adjacent CCN router in operation 530.

Alternatively, if it is determined that there is no adjacent CCN router with a core score equal to or greater than that of the corresponding CCN router, it goes to operation 540.

The CCN router determines whether information about a piece of content stored therein has changed in operation 540.

If it is determined that the information about the stored piece of content has changed in 540, the CCN router goes back to operation 510 and generates a register message.

If it is determined that the information about the stored piece of content has not changed in operation 540, the CCN router determines whether any new register message has been received in operation 550.

If it is determined that a new register message has been received in 540, the CCN router stores information included in the new register message in 550. That is, the CCN router stores information indicating which CCN router each piece of content is stored in and distance from each CCN router.

In addition, the CCN router generates a register message with modified content distance information. That is, content distance information included in the newly received register message is distance from a CCN router which stores the piece of content to the corresponding CCN router. Thus, in order to transmit the new register message to an adjacent CCN router, it is required to modify content distance information. That is, it is necessary to add up another piece of content distance information.

Next, the CCN router goes back to operation 520 to transmit the modified register message to an adjacent CCN router which has a core score equal to or greater than that of the corresponding CCN router.

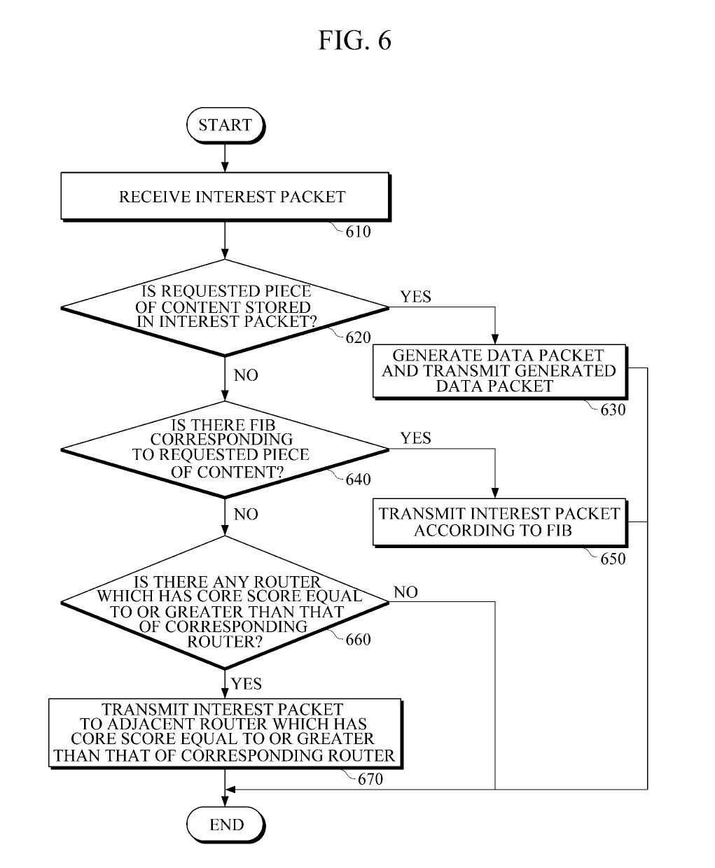

FIG. 6 is a flow chart illustrating a method for searching for a piece of content based on a core score according to an exemplary embodiment of the present invention.

Referring to FIG. 6, a CCN router receives an interest packet in operation 610. The CCN router looks up a content store 111 of its own to see if a piece of content indicated by the interest packet is stored therein in operation 620.

It the piece of content indicated by the interest packet is found in the content store 111 in operation 620, the CCN router generates a data packet including the requested piece of content and transmits the data packet on a reverse path of the interest packet.

Alternatively, if the requested piece of content is not stored in the content store 111, the CCN router determines whether there is an FIB corresponding to the requested piece of content in operation 640.

If it is determined that there is an FIB corresponding to the requested piece of content in operation 640, the CCN router transmits the interest packet based on the FIB in operation 650.

Alternatively, if it is determined that there is no FIB corresponding to the requested piece of content in operation 640, the CCN router transmits the interest packet to an adjacent CCN router which has a core score is equal to or greater than that of the corresponding CCN router.

That is, the CCN router determines whether there is any adjacent CCN router which has a core score equal to or greater than that of the corresponding CCN router in operation 660.

If it is determined that there is an adjacent CCN router whose a core score is equal to or greater than that of the corresponding CCN router in operation 660, the corresponding CCN router transmits the interest packet to the adjacent CCN router.

Alternatively, if it is determined that there is no adjacent CCN router whose a core score is equal to or greater than that of the corresponding CCN router, the CCN router drops the interest packet.

Unlike a conventional CCN control plane, the present invention is able to transmit an interest packet and a data packet without a distributed routing protocol, such as an OSPF protocol, so that a CCN router with a simple configuration may be achieved. In addition, according to the configuration of the present invention, it is possible to reduce categories of an FIB, so that a more significant scalability may be guaranteed.

In addition, when a piece of content is shifted to be located in a different CCN router, a service of providing the piece of content may be resumed simply by transmitting a register packet once from the different CCN router. In light of this, data mobility is supported much more

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for setting a core score in a router on a Content-Centric Network (CCN), the method comprising:
setting a core score according to closeness to a core of a CCN; and
transmitting the core score to one or more adjacent routers.

2. The method of claim 1, wherein the more adjacent to the core of a CCN, the greater the core score is to be set.

3. The method of claim 1, further comprising:
storing a core score transmitted from the one or more adjacent routers.

4. A method for providing content information based on a core score in a router on a CCN, the method comprising:
generating a register message comprising information about a piece of content stored in a router; and
transmitting the generated register message to one or more adjacent routers which have core scores equal to or greater than that of the router.

5. The method of claim 4, wherein the register message comprises a content name, a location of the piece of content and a value representing a distance to the piece of content.

6. The method of claim 4, wherein the generating of the register message comprises modifying the register message if the information about the piece of content stored in the router has changed.

7. A method for providing content information based on a core score in a router on a CCN, the method comprising:
receiving a register message from one or more adjacent routers;
storing the received message;
modifying content distance information included in the received register message; and
transmitting the modified content distance information to one or more adjacent routers which have core scores equal to or greater than that of a corresponding router.

8. The method of claim 7, further comprising:
determining whether the received register message is a newly generated message, wherein if it is determined that the received register message is the newly generated message, the transmitting of the modified content distance information is performed.

9. A method for searching for content information based on a core-score in a router on a CCN, the method comprising:
receiving an interest packet from one or more adjacent routers; and
transmitting the interest packet to one or more routers which have core scores equal to or greater than that of a corresponding router.

10. The method of claim 9, further comprising:
if receiving the interest packet, determining whether a piece of content indicated by the interest packet is stored in the corresponding router; and
if it is determined that the piece of content indicated by the interest packet is stored in the corresponding router, transmitting a data packet comprising the piece of content and transmitting the data packet to the one or more routers which have transmitted the interest packet.

11. The method of claim 9, further comprising:
determining whether there is a Forwarding Information Base (FIB) corresponding to the piece of content; and
if it is determined there is the FIB corresponding to the piece of content, transmitting the interest packet to another adjacent router indicated by the FIB.

12. The method of claim 9, wherein the corresponding router drops the interest packet if there is no adjacent router which has a core score equal to or greater than that of the corresponding router.

13. A router based on a core score, the router comprising:
a core score setting unit configured to set a core score according to closeness to a core of a CCN; and
a core score transmitting/receiving unit configured to transmit the core score to one or more adjacent routers.

14. The router based on a core score of claim 13, wherein the core score transmitting/receiving unit stores a core score transmitted from the one or more adjacent routers.

15. The router based on a core score of claim 13, further comprising:
a register message generating unit configured to generate a register message comprising information about a piece of content stored in the router based on a core score; and
a register message transmitting/receiving unit configured to transmit the generated register message to one or more routers which have core scores equal to or greater than that of the router.

16. The router based on a core score of claim 15, wherein the register message generating unit modifies the register message if the information about the piece of content stored therein has changed.

17. The router based on a core score of claim 15, wherein the register message transmitting/receiving unit stores the register message received from the one or more adjacent routers, modifies content distance information included in the received register message, and transmits the modified register message to one or more adjacent routers which have core scores equal to or greater than that of the router.

18. The router based on a core score of claim 15, the register message transmitting/receiving unit transmits the register message to the one or more adjacent routers only when the register message is a newly generated message.

19. The router based on a core score of claim 13, further comprising:
an interest packet transmitting/receiving unit configured to receive an interest packet from the one or more adjacent routers, and transmits the interest packet to the one or more routers which have core scores equal to or greater than that of the router.

20. The router based on a core score of claim 19, the interest packet transmitting/receiving unit drops the interest packet if there are no routers which have the core scores equal to or greater than that of the router.
